(19) United States
(12) Patent Application Publication
(10) Pub. No.: US 2022/0379841 A1
(43) Pub. Date: Dec. 1, 2022

(54) SMART WATCH

(71) Applicant: Bernard Wagner, Las Vegas, NV (US)

(72) Inventor: Liang Weijian, Guangzhou (CN)

(73) Assignee: Bernard Wagner, Las Vegas, NV (US)

(21) Appl. No.: 17/334,755

(22) Filed: May 30, 2021

(51) Int. Cl. B60R 25/24; G04G 21/04; G04G 17/04; B60R 25/04

(52) U.S. Cl. CPC B60R 25/24; G04G 21/04; G04G 17/04; B60R 25/04; H01Q 1/273

(57) ABSTRACT

Disclosed herein is a traditional metal watch adapted into a smartwatch wherein the smartwatch comprises a circuit module placed within a metal case cover. An antenna on the circuit module is connected to hands of smartwatch through a first metal component thereby providing an electrical path for signals to and from the circuit module. The hands of the smartwatch function as an antenna for transmitting control signals to an external electronic device wherein the control signals are operable to execute one or more functions on the external electronic device.

### TECHNICAL FIELD

The present invention relates generally to electronic devices and specifically to a smart watch configured to operate an external electronic device.

### BACKGROUND

Intelligent automation and smart devices have become part of our day to day lives. These smart devices have made life simpler and convenient for the common people. However, these smart devices need to be operated through a remote controller which is generally provided by the OEM manufacturer of the smart device. But in cases where the remote controller is not available, operating these smart devices becomes difficult. Therefore, it becomes imperative that the remote controller for smart devices is carried around.

One of the solution to the above-mentioned problem of carrying the remote controller around is to integrate the remote controller circuit onto a wearable device such as watch. Traditional watches such as metal watches are generally worn by man people. Hence, integrating the remote controller into the traditional metal watch can solve the problem of carrying around the remote controller. Since the watch would function as remote controller, there is no more need of carrying the remote controller.

However, the traditional metal watch has a metal case cover that prohibits signals being transmitted from an antenna of the remote controller circuit to outside the metal case directed towards the smart device. Therefore, simply placing the electronic circuit within the metal case of the metal watch does not substitute the function of remote electronic controller capable of transmitting and receiving signals.

In light of the above mentioned problem associated with portable remote controllers for smart devices, it is desirable to have a method and an apparatus for communicating signals to and from metal watches to external electronic smart devices.

### SUMMARY

Embodiments of the present disclosure present technological improvements as solutions to one or more of the above-mentioned technical problems recognized by the inventor in conventional solutions.

The present invention discloses a traditional metal watch adapted into a smartwatch wherein the smartwatch comprises a circuit module placed within a metal case cover. An antenna on the circuit module is connected to hands of smartwatch through a first metal component thereby providing an electrical path for signals to and from the circuit module. The hands of the smartwatch function as an antenna for transmitting control signals to an external electronic device wherein the control signals are operable to execute one or more functions on the external electronic device.

Additional aspects, advantages, features, and objects of the present disclosure would be made apparent from the drawings and the detailed description of the illustrative embodiments construed in conjunction with the complete specification that will follow.

It will be appreciated that features of the present disclosure are susceptible to being combined in various combinations without departing from the scope of the present disclosure.

### BRIEF DESCRIPTION OF DRAWINGS

The summary above, as well as the following description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts an exemplary smartwatch as per the disclosed invention.

FIG. 2 depicts a smartwatch with the one or more buttons.

FIG. 3 depicts a sectional view of the smart watch.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

The following description illustrates embodiments of the present disclosure and the ways in which they can be implemented. Although some modes of carrying out the present disclosure have been disclosed, those skilled in the art would recognize that other embodiments for carrying out or practicing the present disclosure are also possible.

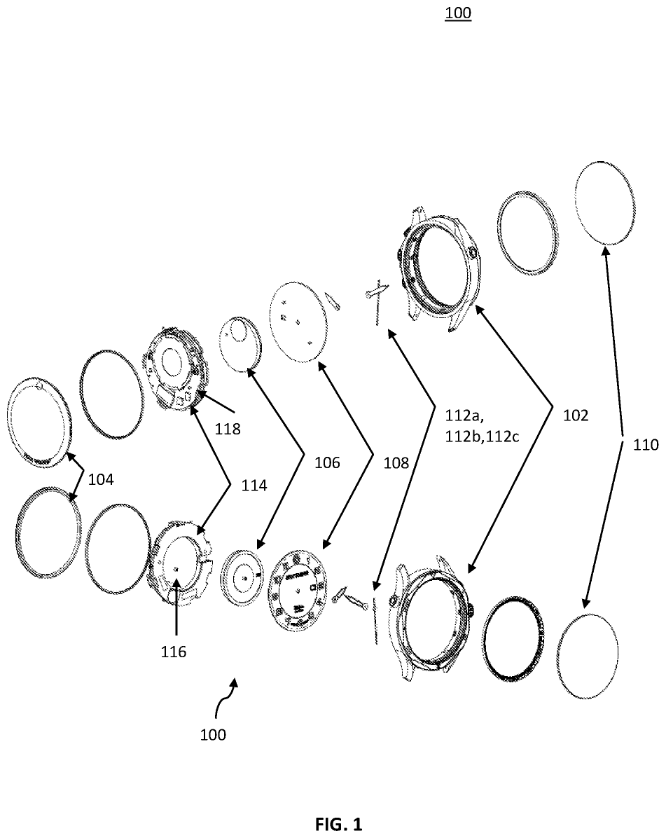

FIG. 1 describes an exploded view of the smartwatch 100 as per an exemplary the present invention wherein the smartwatch is configured to transmit a control signal to an external device. The smartwatch 100 is a traditional watch with metal casing that includes crystals, a bezel, a metal case 102, a bottom metal case cover 104, a Movement 106, dial 108 along with a glass cover 110 and one or more hands 112a, 112b, 112c. The Movement is mounted on the bottom of the Dial 108. The Movement is the engine of a watch that acts as the powerhouse to make the watch and its functions operate. This internal mechanism makes the hands of the watch move. There are centre posts for the one or more hands on the Movement on which the one or more hands are mounted. The posts go through the centre hole on the Dial. The one or more hands include the Hour Hand, the Minute Hand and the Second Hand. The one or more hands are working on the space between the Dial and the glass cover 110.

It shall be appreciated by person skilled in the art that the traditional metal watch as described herein is one which is conventionally found in the industry and is not being claimed as the novel aspect of the present invention.

Throughout this disclosure, the term “external electronic device” refers to an electronic module physically separated from the smartwatch and communicable through communication signals through one or more communication channels. The one or more communication channels can be RF communication, Bluetooth, Wi-Fi etc. In an example embodiment, the external electronic device is an electronic controller of an automobile operable for keyless entry and engine start/stop. Optionally, the external device could be a signal operated lid or an actuator device. Alternatively, the external electronic device is another smart device.

The smartwatch 100 further comprises a circuit module 114. In an aspect of the present invention, the circuit module 114 is placed inside a metal case 102 of the smartwatch 100. The circuit module 114 consists of an antenna and an electronic circuit board. The antenna is used to transmit a control signal to the external electronic device. The circuit module 114 is placed between a bottom side of the dial 108 and a bottom metal case cover 104 of the smartwatch 100. As per the example embodiment, the circuit module 114 is an electronic circuit for keyless entry system for an automobile and is operable for communicating with an electronic controller on the automobile configured for keyless entry system. Keyless entry systems are used to remotely lock, unlock and start a car's engine using RF signals.

Throughout the disclosure, the term “control signal” means an actuating signal which is operable to change state of an electronic circuit. As a non-limiting example, a control signal can be a RF signal for engaging a door lock of the automobile. Alternatively, the control signal can be an authentication signal for remote electronic operation of an ignition system for an automobile engine.

It shall be further appreciated that said circuit modules can be of various configurations in terms of electronic schematic and technology and all such variations, where the output of the circuit module is to transmit an electronic signal given a distinct input, are covered within the scope of this disclosure.

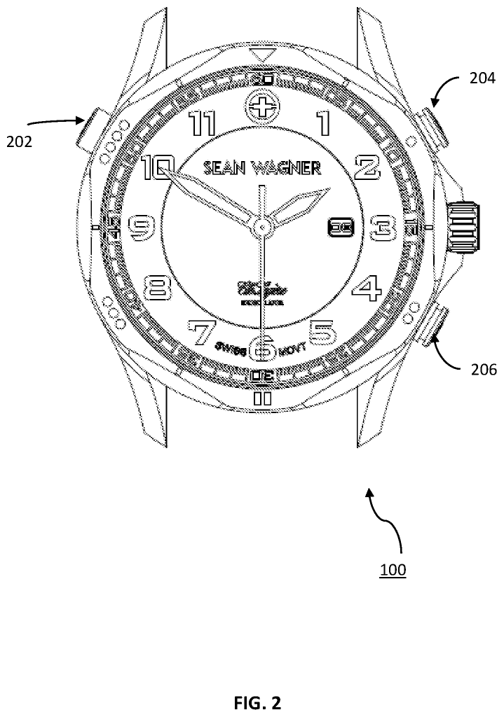

In an aspect of the present invention, one or more buttons on the smartwatch are configured to control at least one function of the circuit module. FIG. 2 depicts a smartwatch with the one or more buttons 2H, 4H, 6H, 10H and so on. The said buttons 202 (2H), 204 (4H), 206 (6H) are connected to at least one input pin on the circuit module wherein pressing either of the said buttons results in a distinct input signal being provided to the circuit module and subsequently a correspond control signal through the antenna of the circuit module. In the example embodiment, one or more buttons on the smart watch have been configured to engage/disengage a door lock of an automobile. In effect, the buttons are connected to corresponding input pins on the circuit module and when pressed, the circuit module transmits a control signal to engage/disengage the door lock of the automobile. Optionally, the one or more buttons when pressed may change the state of the electronic circuit in the circuit module and the circuit module may wait for an input signal to be received via the antenna of the circuit module.

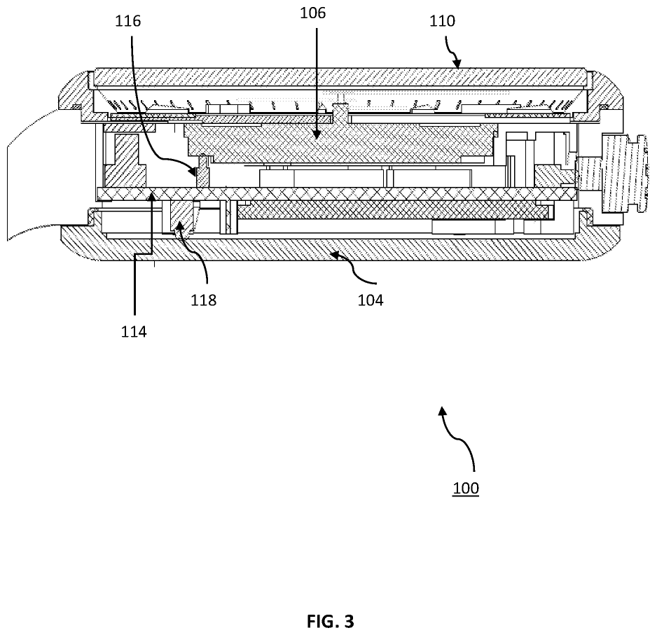

In yet another aspect, a first metal component 116 connects the antenna of the circuit module to one or more hands of the smart watch 100. The first metal component 116 is a part of the antenna on the circuit module 114. The first metal component 116 is a metal spring. Optionally, the first metal component 116 is a metal pin. The first metal component 116 is connected to a metal area on a bottom side of the movement 106 of the smart watch. The one or more hands of the smartwatch are made of metal and are mount on posts of the movement 106 connected through metal gears. One end of the first metal component 116 that connects to the metal area on the bottom of the movement 106 is electrically connected to the one or more hands of the smartwatch since all parts are made of metal and therefore are good conductors of electricity. The other end of the first metal component 116 is connected to the antenna of the circuit module 114. Therefore, the one or more hands of the smart watch are electrically connected to the antenna of the circuit module 114 through the movement 106 of the smart watch and the first metal component 116. The one or more hands of the smartwatch operate as an antenna since they are electrically connected to the antenna on the circuit module 114, and transmit a control signal generated by the circuit module 114 to the external electronic device. FIG. 3 depicts a sectional view of the smart watch.

In yet another aspect of the present invention, a second metal component 118 connects the circuit module 114 to the bottom metal case cover of the smart watch 100. One end of the second metal component 118 is part of the ground electrode of the circuit module 114. Since the other end of the second metal component 118 is connected to the bottom metal case cover, the bottom metal case cover becomes a part of the ground electrode for the circuit module 114. Moreover, since the bottom metal case cover 104 touches a user's skin when the user wears the smart watch, signal is further enhanced due to human body being an excellent electrical ground. The second metal component 118 is a metal pin or a metal spring like the first metal component 116.

The first metal component 116 and the second metal component 118 are soldered to form an electrical connection with the respective ends.

In operation, as per the example embodiment, a user wearing the smartwatch presses a button 2H on the smartwatch. The button 2H when pressed, sends an input to the circuit module for opening a door lock of an automobile. The input signal is processed and a corresponding control signal is generated wherein the control signal is operable to disengage the door lock of the automobile. The control signal is transmitted from the antenna of the circuit module and relayed to the one or more hands of the smart watch through the first metal component and the movement. The one or more hands of the smartwatch then transmit the control signal to the external electronic device which in the example embodiment is the electronic controller on the automobile operable to control the electronic door lock. The door lock is disengaged on receiving the control signal and automobile door opens. Similarly, on pressing 4H button, another input pin is selected on the circuit module and said input signal is provided to the circuit module. The said input signal is processed and a corresponding control signal is generated wherein the control signal is operable to engage the door lock of the automobile. Said control signal is transmitted from the antenna of the circuit module to the external electronic device through the one or more hands of the smartwatch through the first metal component and the movement. The door lock is engaged on receiving the control signal and the automobile door closes. Optionally, the one or more buttons relate to engine start and engine stop. In said embodiment, the control signal generated by the circuit module is received by an electronic controller on the automobile responsible for operation of ignition system of the automobile.

In another embodiment, the one or more hands of the smart watch is operable to receive at least one control signal from an external electronic device and relay the received control signal to the antenna of the circuit module through the movement and the first metal component. The received control signal is configured to change a state of the electronic circuit of the circuit module. Alternatively, the received control signal acts as an input signal for the circuit module.

In yet another embodiment, the one or more hands of the smartwatch is operable to work both as a transmitter and a receiver of signals simultaneously. In operation, the one or more hands of the smartwatch receives an input signal from an external electronic device and relays the same to the antenna of the circuit module through the movement and the first metal component of the smart watch. The circuit module receives the input signal through the antenna and processes the same to generate a control signal. The control signal is then transmitted through the antenna to the one or more hands of the smartwatch through the movement and the first metal component. The one or more hands then transmit the control signal to the external electronic device. Simultaneous reception and transmission of signals through the one or more hands of the smart watch is thus achieved.

In an embodiment, an application software installed on a smartphone of the user is operable to communicate with the circuit module placed within the watch. One or more control signals received and transmitted by the circuit module are recorded by the application software.

The specific details of particular embodiments may be combined in any suitable manner without departing from the spirit and scope of embodiments of the invention. However, other embodiments of the invention may be involving specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

One or more components of the invention are described as modules for the understanding of the specification. For example, a module may include a self-contained component in a hardware circuit comprising of the logical gate, semiconductor device, integrated circuits, or any other discrete component. The module may also be a part of any software program executed by any hardware entity for example processor. The implementation of a module as a software program may include a set of logical instructions to be executed by a processor or any other hardware entity. Additional or fewer modules can be included without deviating from the novel art of this disclosure. In addition, each unit can include any number and combination of sub-units, and systems, implemented with any combination of hardware and/or software units.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components, or elements not explicitly described also to be present. Reference to the singular is also to be construed to relate to the plural. A recitation of “a”, “an” or “the” is intended to mean “one or more” unless specifically indicated to the contrary. The use of “or” is intended to mean an “inclusive or,” and not an “exclusive or” unless specifically indicated to the contrary.

1. A smart watch configured to transmit a control signal to an external electronic device, the smart watch comprising:
a circuit module placed inside a metal case of the smart watch;
a first metal component connecting an antenna of the circuit module to one or more hands of the smart watch;
a second metal component connecting the circuit module to a bottom metal case cover of the smart watch;
wherein the circuit module is operable to transmit the control signal to the external electronic device using one or more hands of the smart watch.

2. The smart watch of claim 1 wherein the first metal component is connected to a metal area on a bottom side of the movement of the metal watch.

3. The smart watch of claim 1 wherein the one or more hands of the smart watch are electrically connected to the antenna of the circuit module through the movement of the smart watch.

4. The smart watch of claim 1 wherein the first metal component is a metal spring.

5. The smart watch of claim 1 wherein the bottom metal case cover is a part of the ground electrode for the circuit module.

6. The smart watch of claim 1 wherein the external electronic device is an automobile with electronic controls enabled.

7. The smart watch of claim 1 wherein the circuit module is operable to emulate functions similar to a remote control key of the automobile.

8. The smart watch of claim 1 wherein one or more buttons on the smart watch are configured to control at least one function of the remote control.

9. The smart watch of claim 1 wherein the at least one function include an engine start/stop function.

10. The smart watch of claim 1 wherein the circuit module is operable to receive at least one control signal from the external electronic device through the one or more hands of the smart watch.

11. A method of controlling, through a smart watch, at least one function of a remote control associated with an automobile, the method comprising:
generating a control signal from a circuit module placed inside a metal case of the smart watch;
relaying the control signal from an antenna of the circuit module to one or more hands of the smart watch;
transmitting the control signal from the one or more hands of the smart watch to the external electronic device;
wherein the one or more hands of the smart watch are connected to the antenna to the circuit module through a first metal component and a second metal component connects the circuit module to a bottom metal case cover of the smart watch.

12. The method of claim 12 wherein the first metal component is connected to a metal area on a bottom side of the movement of the metal watch.

13. The method of claim 12 wherein the one or more hands of the smart watch are electrically connected to the antenna of the circuit module through the movement of the smart watch.

14. The method of claim 12 wherein the first metal component is a metal spring.

15. The method of claim 12 wherein the bottom metal case cover is a part of the ground electrode for the circuit module.

16. The method of claim 12 wherein the external electronic device is an automobile with electronic controls enabled.

17. The method of claim 12 wherein the circuit module is operable to emulate functions similar to a remote control key of the automobile.

18. The method of claim 12 wherein one or more buttons on the smart watch are configured to control at least one function of the remote control.

19. The method of claim 12 wherein the at least one function include an engine start/stop function.

20. The method of claim 12 wherein the circuit module is operable to receive at least one control signal from the external electronic device through the one or more hands of the smart watch.
